(19) United States
(12) Patent Application Publication
(10) Pub. No.: US 2002/0116721 A1
(43) Pub. Date: Aug. 22, 2002

(54) Method and system of expanding a customer base of a data services provider

(75) Inventors: Ronald Keith Dobes, Potomac Falls, VA (US); Eugene Lee Lew, Olney, MD (US); Leo Charles Cloutier, Falls Church, VA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: GEMINI NETWORKS, INC., Falls Church, VA (US)

(21) Appl. No.: 09/784,068

(22) Filed: Feb. 16, 2001

(51) Int. Cl. H04N 7/173

(52) U.S. Cl. 725/129; 725/111

(57) ABSTRACT

A method for expanding customer bases for data services providers. The method includes connecting end-users of a plurality of services providers to a high-speed network dedicated to broadband data transport services. The end-users are connected to the respective headends of their services providers through a common data center of the high-speed network. The high-speed network is owned by a third party, that third party not being any of the services providers having end-users connected to the high-speed network.

### CROSS REFERENCE TO RELATED PATENT DOCUMENTS

The present document contains subject matter related to that disclosed in commonly owned, co-pending application Ser. No. XX/XXX,XXX filed Feb. 16, 2001, entitled SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM (Attorney Docket No. 200876US-8); application Ser. No. XX/XXX,XXX filed Feb. 16, 2001, entitled SYSTEM, METHOD, AND COMPUTER PROGRAM PRODUCT FOR END-USER SELF-AUTHENTICATION (Attorney Docket No. 202585US-8); application Ser. No. XX/XXX,XXX filed Feb. 16, 2001, entitled SYSTEM, METHOD, AND COMPUTER PROGRAM PRODUCT FOR SUPPORTING MULTIPLE SERVICE PROVIDERS WITH A TROUBLE TICKET CAPABILITY (Attorney Docket No. 202586US-8); Provisional Application Serial No. XX/XXX,XXX filed Feb. 16,2001, entitled SYSTEM, METHOD, AND COMPUTER PROGRAM PRODUCT FOR DYNAMIC BANDWIDTH QUALITY OF SERVICE (QOS) PROVISIONING (Attorney Docket No. 202661US-8 PROV); Provisional Application Serial No. XX/XXX,XXX filed Feb. 16, 2001, entitled SYSTEM, METHOD, AND COMPUTER PROGRAM PRODUCT FOR DYNAMIC BANDWIDTH PROVISIONING (Attorney Docket No. 202663US-8 PROV); Provisional Application Serial No. XX/XXX,XXX filed Feb. 16,2001, entitled SYSTEM, METHOD, AND COMPUTER PROGRAM PRODUCT FOR END-USER SERVICE PROVIDER SELECTION (Attorney Docket No. 202664US-8 PROV), and Provisional Application Serial No. XX/XXX,XXX filed Feb. 16, 2001, entitled SYSTEM, METHOD, AND COMPUTER PROGRAM PRODUCT FOR AN IRREVOCABLE RIGHT TO USE (IRU) MODEM REGISTRATION PROCESS (Attorney Docket No. 203050US-8 PROV), the entire contents of each of which being incorporated herein by reference.

### BACKGROUND OF THE INVENTION

1. Field of the Invention

The present invention relates to an integrated operations support system, method, and computer program product for supporting multiple service provider customers.

2. Discussion of the Background

FIG. 1 is a block diagram of a conventional hybrid fiber optic/coaxial (HFC) network for providing cable television service and access to the Internet over the same cable television provider network. As shown in FIG. 1, the fiber optic network, including both video content and data, is tapped via a tap 102 of a coaxial cable run from a fiber node 101. From the tap 102, a coaxial cable (i.e., a drop) is run to a splitter 103 where the signal is split into its data and cable television content components. The cable television content is run via a coaxial cable to a television set 104. The data portion of the signal is sent via a coaxial cable to a cable modem 105 connected to, for example, a personal computer 106.

In order to ensure interoperability and availability of parts, the devices used in this system comply with industry standards such as the Data Over Cable Service Interface Specification (DOCSIS). In a typical DOCSIS-compliant system, a network having 860 MHz of bandwidth will allocate the band of 5-42 MHz for upstream communications, and the band of 88-860 MHz for downstream communications.

The cable modem termination system (CMTS) 107 provides an interface between the cable network and the Internet. The CMTS 107 provides the data signal to the cable headend 108 which in turn provides connectivity to a backbone 109 provider. The backbone 109 provides the connectivity to the communications network 100, for example, the Internet. The backbone 109 is a network configured to provide access to the Internet. Access to the backbone 109 is provided by, for example, organizations such as UUNET.

The DOCSIS standard applies to all equipment between the cable modem 105 and the CMTS 107. Accordingly, DOCSIS defines a protocol through which existing cable networks may also be used to provide high-speed bidirectional Internet access.

FIG. 2 is a block diagram showing a conventional dial-up network configuration for providing access to the Internet via an existing telephone network. As shown in FIG. 2, an end-user may connect to the network via a personal computer 201 having, for example, a digital subscriber line (DSL) modem 200. The DSL modem 200 interfaces with the telephone network through a digital subscriber line access multiplexer (DSLAM) 202. Similar to the CMTS 107 shown in FIG. 1, the DSLAM 202 is connected to a backbone 109 through a headend 203. The backbone 109, which may be the same backbone 109 shown in FIG. 1, provides connectivity to the Internet 100.

DSL technology allows digital data to coexist with analog voice data over plain old telephone service (POTS) copper wire networks. As DOCSIS enables the use of existing cable networks for Internet access, technologies such as DSL enable the use of existing telephone networks for Internet access.

As the Internet has become a ubiquitous facet of our society, it is understandable that technologies such as DSL and DOCSIS have well-positioned the telephone companies and the cable television (CATV) companies to benefit. The phone companies and the CATV companies had preexisting networks in place providing connectivity to a large percentage of commercial facilities and residences which desire Internet access. As the technologies evolved permitting multiple uses for the preexisting networks, the telephone companies and cable television providers were able to provide additional services to their existing customer base.

New businesses have also developed in response to the demand for Internet access. For example, @HOME's business model is to provide high-speed broadband Internet access services to end-users. They do this by entering into agreements with existing CATV companies so as to gain access to the preexisting CATV HFC network. By owning their own headend, they can provide Internet access to end-users by providing connectivity, through their headend, from the CMTS 107 to the backbone 109.

Other Internet service providers (ISPs) make use of the preexisting telephone system network to gain access to end-users. Similar to the @HOME model, these ISPs own their own headend, and provide Internet access to end-users by providing connectivity, through their headend, from the DSLAM 202 to the backbone 109. The existing network owners (i.e., the CATV companies and the telephone companies) have developed systems for provisioning new customers, monitoring network status, and for generating billing for network usage. However, these systems have been evolutionary and have not been developed as a single system, but rather, a collection of separate systems, each having their own interfaces and databases. This has led to significant challenges in maintaining data integrity across the systems, and has also impacted user productivity. Not only do the network owners have to deal with these complexities and inefficiencies, but also, the ISPs connecting to these networks must develop interfaces, oftentimes manual interfaces, between the ISP's internal systems and the network owner's systems. This problem is even worse for an ISP such as @HOME which has agreements with many CATV companies, each of which has its own heterogeneous system. It becomes increasingly difficult for an ISP to manage its own systems each time an agreement with a new CATV company or a new telephone company having different systems is reached.

As a general statement, ISPs provide the service of connecting end-users to the Internet by entering into agreements with the owners of the existing networks (i.e., the telephone network and CATV networks), and with the providers of the backbone 109 networks (e.g., UUNET). ISPs typically provide a number of services for their customers, for example, e-mail, news, software downloads, etc. Moreover, ISPs provide a single point of contact for an end-user, alleviating the need for each end-user to interact with the network owner and/or the backbone 109 provider regarding their Internet connectivity.

### SUMMARY OF THE INVENTION

The inventors of the present invention have recognized that currently no methods, or systems are available to allow Internet service providers (ISPs) to grow their end-user base in an open access environment. Accordingly, one object of the present invention is to provide a solution to this problem, as well as other problems and deficiencies associated with managing the relationships involved in providing an open access network dedicated to broadband data transport services.

The inventors of the present invention have also recognized that it would be advantageous to provide a high-speed network dedicated to broadband data transport services as a way of providing cable television (CATV) operators a vehicle through which they may expand the geographic boundaries of their Internet service provider business beyond the limits of their CATV franchise award. Accordingly, a further object of the present invention is to provide a high-speed network dedicated to broadband data transport services having a common data center through which many ISPs (both CATV operator ISPs and other ISPs) may manage their customers connected to that network. The high-speed network is an open access network providing connectivity between end-users and ISP headends thereby allowing ISPs to offer upgraded service to their existing customer base as well as to extend their customer base without geographic limitations based on CATV or telephone network availability. The ISPs provide the connectivity from the high-speed network to, for example, an Internet backbone provider such as UUNET.

The above described and other objects are addressed by the present invention which includes a novel method and system through which a high-speed network dedicated to broadband data transport services may be managed and through which customers (e.g., ISPs) having end-users connected to the high-speed network may administer the usage of that network. Because the high-speed network is dedicated to broadband data transport services, it is not geographically limited by a franchise award, as would a CATV network. Moreover, the high-speed network does not need to allocate a significant portion of its bandwidth for downstream video, as is done with conventional multi-use CATV networks. Accordingly, cable television operators providing ISP services may manage end-users connected to the high-speed network as a way of not only providing superior service, but also broadening the geographic reaches of their ISP business.

In one embodiment, the present invention is implemented as a method for expanding customer bases for data services providers. The method includes connecting end-users of a plurality of services providers to a high-speed network dedicated to broadband data transport services. The end-users are connected to the respective headends of their services providers through a common data center of the high-speed network. The high-speed network is owned by a third party, that third party not being any of the services providers having end-users connected the high-speed network.

Consistent with the title of this section, the above summary is not intended to be an exhaustive discussion of all the features or embodiments of the present invention. A more complete, although not necessarily exhaustive, description of the features and embodiments of the invention is found in the section entitled “DESCRIPTION OF THE PREFERRED EMBODIMENTS.”

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of a typical system configuration of a hybrid fiber optic/coaxial (HFC) network for providing cable television service and access to the Internet through the cable television provider network;

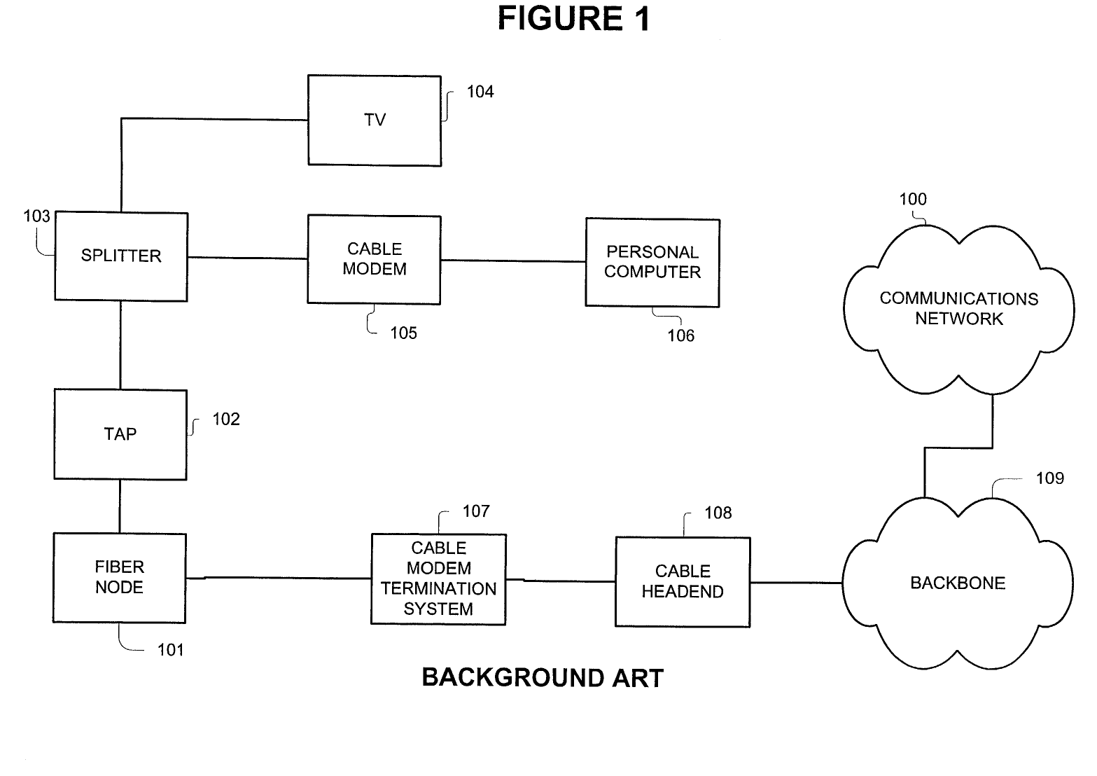

FIG. 2 is a block diagram of a typical dial-up network providing access to the Internet over phone lines;

FIG. 3 is a block diagram of a high-speed network system dedicated to broadband transport data services (e.g., connecting to an ISP headend to gain access to the Internet) connected to a conventional HFC network providing both cable television and access to a communications network according to one embodiment of the present invention;

FIG. 4 is a block diagram showing the connectivity of multiple hybrid fiber optic/coaxial networks through a single data center of a high-speed network according to one embodiment of the present invention;

FIG. 5 is a block diagram showing the connectivity of remote end-users to geographically based service providers (e.g., an Internet service provider (ISP)) through a high-speed network in one embodiment of the present invention;

FIG. 6 is block diagram showing the connectivity between a common data center of a high-speed network as shown in FIG. 4 and a service provider's (e.g., an ISP) system according to one embodiment of the present invention;

FIG. 7 is a block diagram of a system configuration of an operations support system of a high-speed network to support multiple service providers according to one embodiment of the present invention;

FIG. 8 is a block diagram showing the software architecture of a system for an integrated operations support system of a high-speed network to support multiple service providers according to one embodiment of the present invention;

FIG. 9 shows an exemplary database structure for a database of an operations support system of a high-speed network supporting multiple service providers (e.g., ISPs) according to one embodiment of the present invention;

FIG. 10 is a flow diagram showing a process for provisioning a new end-user using an operations support system according to one embodiment of the present invention;

FIG. 11 is a flow diagram showing a process for setting up a new end-user using an operations support system according to one embodiment of the present invention;

FIG. 12 is a flow diagram showing a process through which an end-user of a high-speed network dedicated to broadband data services may self-authenticate according to one embodiment of the present invention;

FIG. 13 is a flow diagram showing a process for handling trouble tickets using an operations support system according to one embodiment of the present invention;

FIG. 14 is a flow diagram showing a process through which a single trouble ticketing system may concurrently support many service providers according to one embodiment of the present invention; and

FIG. 15 is an exemplary computer system programmed to perform one or more of the special purpose functions of the present invention.

### DETAILED DESCRIPTION OF THE PREFERRED EMBODIMENTS

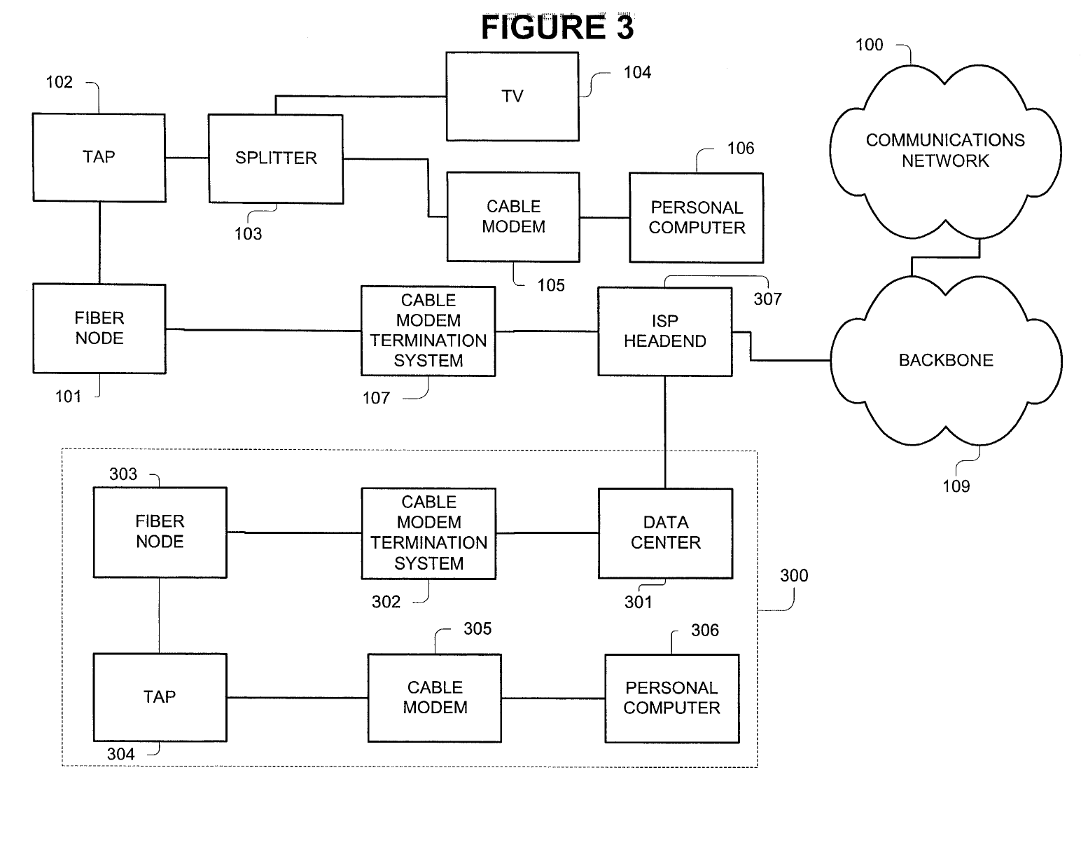

Referring now to the drawings, wherein like reference numerals designate identical or corresponding parts throughout the several views, and more particularly to FIG. 3 thereof, which is a block diagram of a system dedicated to providing broadband data services, including access to a communications network (e.g., the Internet) according to one embodiment of the present invention. The system includes a high-speed network 300 dedicated to broadband data transport services. In one embodiment of the present invention, the high-speed network 300 provides end-users with connectivity to an Internet service provider (ISP) headend 307 to gain access to a communications network 100, for example, the Internet. This connectivity may be provided by using the Data Over Cable Service Interface Specification (DOCSIS) protocol for communications between the end-user cable modem 305 and the cable modem termination system (CMTS) 302 of the high-speed network 300. In further embodiments, protocols other than DOCSIS may be used (e.g., Euro-DOCSIS, fast Ethernet, gigabit Ethernet or other proprietary protocols). In another embodiment, the high-speed network 300 provides end-users with connectivity to an Internet backbone network directly (i.e., via the data center 301) on behalf of the ISP. In further embodiments, the high-speed network 300 dedicated to broadband data transport services provides voice over Internet Protocol (IP) services or video on demand services. The embodiments described herein will be in the context of providing high-speed access to the Internet by providing end-users with connectivity to ISP headends 307. However, as discussed above, the invention is not limited to this particular embodiment nor is it limited to providing access to any particular network.

The high-speed network 300 is a hybrid fiber optic/coaxial (HFC) network similar to existing cable television (CATV) plants. The high-speed network 300 provides connectivity from end-users, for example, through a personal computer 306 having a cable modem 305, through a coaxial cable to a tap 304 of the fiber optic network. The tap 304 connects the end-user to the coaxial cable portion of the HFC network that connects to the fiber optic network at a node 303. The cable modem 305 communicates with the cable modem termination system (CMTS) 302, which in turn provides connectivity for all end-users of the high-speed network 300 to a common data center 301.

The data center 301 provides connectivity from the dedicated high-speed network to an Internet service provider's (ISP) headend 307. The ISP headend 307 is the same headend as described in the BACKGROUND OF THE INVENTION section. For example, the ISP headend 307 may be a cable headend 108 of an ISP providing Internet access over an existing cable network, or it may be a headend 203 of an ISP providing Internet access through dialup connections. In one embodiment of the present invention, the high-speed network 300 provides connectivity to a plurality of ISP headends 307. For example, the end-users from CATV operator ISPs and dial-up ISPs coexist on the same high-speed network 300. The data center 301 is responsible for managing the connectivity between the various ISPs and their particular end-user customers. The ISP headend 307 provides the connectivity to the backbone 109, as described above, which in turn provides the connectivity to the communications network 100, for example, the Internet. Various approaches for connecting to the Internet, including DSL and cable modem connections, are described in White, R., “How Computers Work,” Que, September 1999, and Gralla, P. “How the Internet Works,” Que, August 1999, the entire contents of both of which are incorporated herein by reference.

FIG. 3 illustrates two different networks for gaining access to the Internet 100 through a common ISP headend 307. As discussed above, one path is through the high-speed network 300 dedicated to providing broadband data transport services. The other is a preexisting CATV network that provides both cable television content and Internet access. The cable television signal is separated from the data signal at the splitter 103, the cable television signal is provided to a television 104, while the data signal is provided to a cable modem 105 connected to a personal computer 106. The splitter 103 is connected via a coaxial cable to the tap 102. The tap 102 connects the end-user to the coaxial cable portion of the HFC network that in turn connects to the to the fiber optic network at the fiber node 101. The cable modem termination system (CMTS) 107 communicates with the cable modem 105 and provides connectivity to the common ISP headend 307.

The inventors of the present invention have recognized that by providing a high-speed network 300 dedicated to broadband data transport services, as compared to sharing a preexisting network built for cable television or telephone use, significant improvements in performance may be achieved. A significant portion of the bandwidth of preexisting CATV networks is dedicated to the downstream transmission of the cable television video. For example, a seventy-channel analog video system requires 420 MHz of bandwidth (6 MHz per channel). Accordingly, standards have been developed to work around that limitation. For example, the Data Over Cable Service Interface Specification (DOCSIS) standard provides that, for an 860 MHz bandwidth channel, the band from 88 MHz to 860 MHz would be reserved for downstream communications. Consequently, devices built for use in a data over cable system must limit their upstream bandwidth to the first 42 MHz. Such allocation limitations do not exist on a high-speed network 300 dedicated to broadband data transport services.

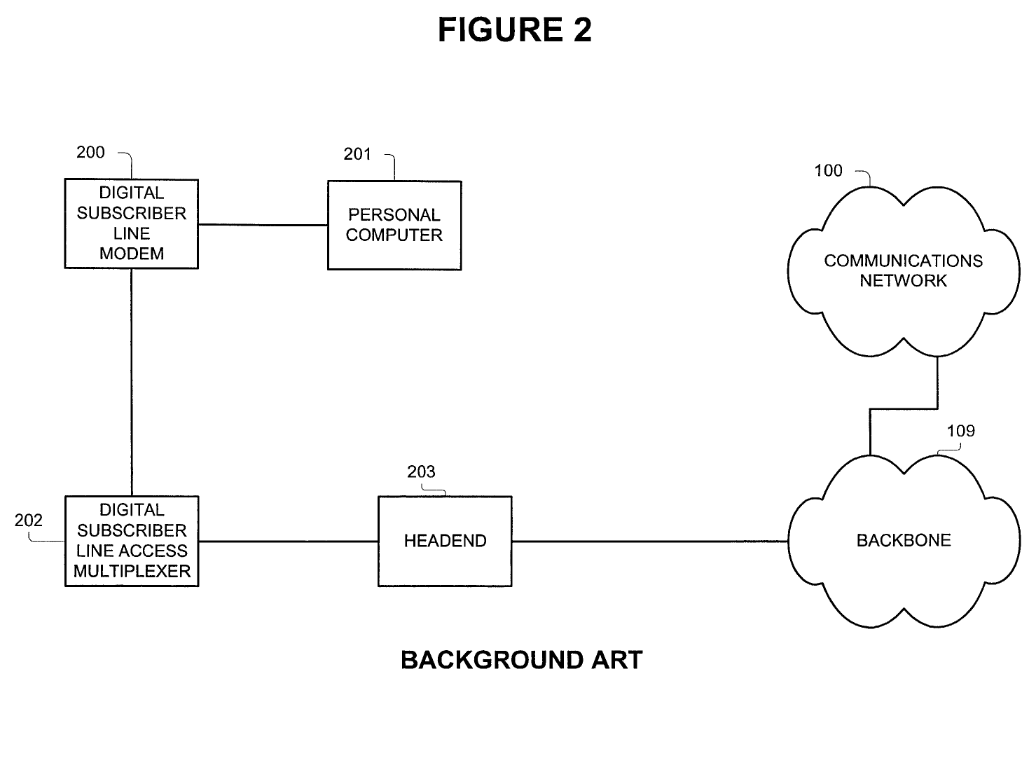

FIG. 3 provides an example showing an ISP headend 307 for a cable provider that also provides Internet access over their cable network. However, this is an exemplary illustration only. The ISP headend 307 could also be a headend 203 for an ISP providing Internet access over telephone lines, as shown in FIG. 2. Alternatively, the ISP headend 307 could be a headend for an Internet service provider such as @HOME that provides Internet access through affiliations with various owners of preexisting networks. Moreover, multiple ISP headends 307, of varying types, may be connected to the high-speed network 300 dedicated to broadband data services.

FIG. 3 illustrates that, in one embodiment of the present invention, an ISP may have connectivity to some customers (i.e., end-users) connected to the ISP headend 307 through its own network, for example, the personal computer 106 connected to the ISP headend 307 through the CMTS 107. In addition, that same ISP may have customers connected to a different, high-speed network 300 dedicated to broadband data transport services, for example, the personal computer 306 connected to the data center 301 through the CMTS 302. Accordingly, FIG. 3 illustrates that, in one embodiment of the present invention, an ISP may provide services to end-users connected to different networks. In this embodiment, the ISP maintains the relationship with the end-users. If the ISP owns their own network (e.g., a cable television operator) they are responsible for that physical plant as well. If, on the other hand, the ISP does not operate a network (e.g., the @HOME example discussed above, where the ISP enters into agreements with the network operators), the ISP must coordinate with the operators of the networks concerning network status, outages, etc. The operator of the high-speed network 300 is responsible for the operation of that plant, and network status information is made available to those ISPs having customers connected to the high-speed network 300.

As discussed above, the present inventors have recognized that Internet connectivity through a high-speed network 300 dedicated to broadband data transport services provides superior performance over conventional approaches. Accordingly, using the system configuration shown in FIG. 3, an ISP could offer enhanced performance to its customers through providing Internet connectivity via the high-speed network 300, rather than via the preexisting cable television network. Moreover, the present inventors have recognized that by providing a high-speed network 300 based on an open access model, many ISPs can expand their customer base by being able to offer their services in geographic regions not currently served, and moreover, ISPs may offer upgraded performance to new and existing customers by connecting those customers to the high-speed network 300 dedicated to broadband data transport services. Because the high-speed network 300 is dedicated to broadband data services (i.e., does not have the limitations associated with, for example, providing analog video), the high-speed network 300 will be able to support new network technologies that may either coexist with or replace standards that have been developed to accommodate those limitations (e.g., DOCSIS).

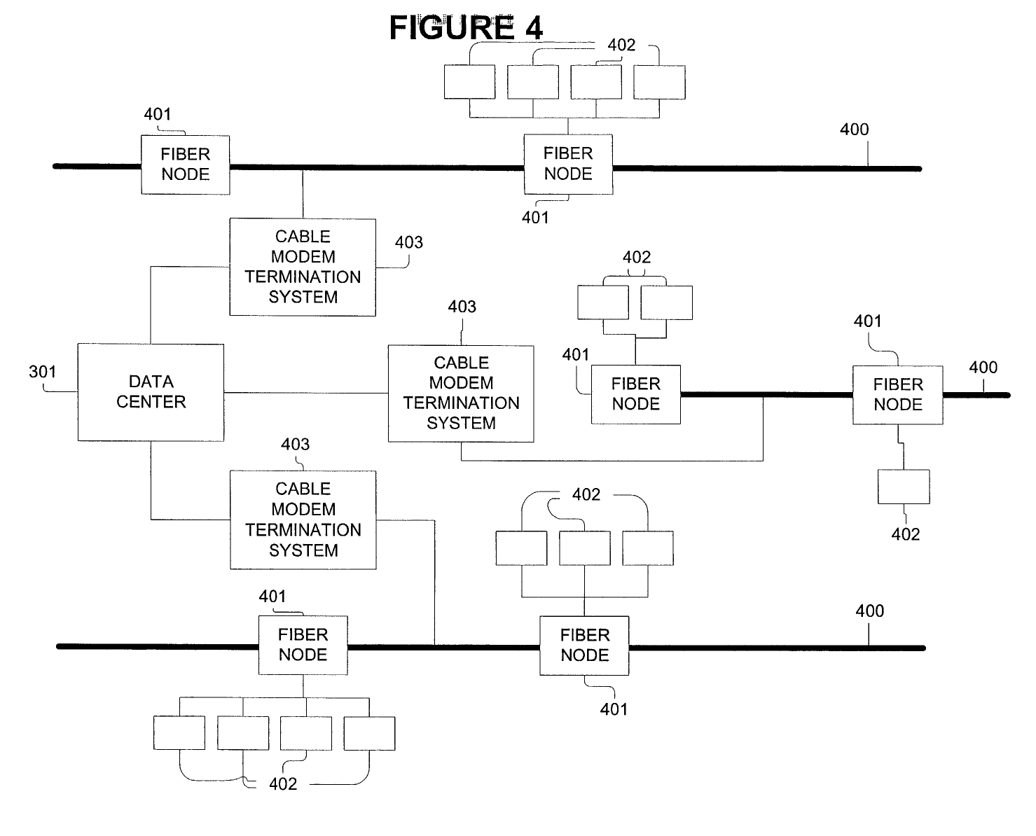

FIG. 4 is a block diagram showing the connectivity of multiple HFC networks through a single data center 301 highlighting another aspect of the present invention. As shown in FIG. 4, the high-speed network simplified as box 300 in FIG. 3 may include several HFC networks 400 that may be geographically dispersed. Each of the HFC networks includes one or more fiber optic nodes 401 that provide connectivity between the fiber optic portion of the network and the coaxial cable portion of the network. For example, each fiber optic node 401 may have connected thereto several end-users 402 via a coaxial cable network. Each end-user 402 is connected to the network, for example, through a cable modem 305. Each of the fiber optic networks 400 is connected to the common data center 301 via a CMTS 403. The common data center 301 provides the connectivity between the geographically dispersed end-users 402 and the various ISP headends 307 having customers on the high-speed network 300.

It was the present inventors who recognized that a limitation faced by cable television providers also providing Internet access was that the CATV network was necessarily limited by the geographic restrictions of the franchise agreements awarded to the cable companies. Accordingly, the reach of a cable company extended only to those end-users within the geographic boundaries of the cable company franchise award. The present inventors recognized that by not tying broadband Internet access services to an HFC system primarily dedicated to carrying analog video signals required by a CATV franchise award, that the high-speed network 300 dedicated to broadband data transport services would not be subject to franchise-based geographic restrictions. Accordingly, not only will the dedicated high-speed network 300 provide superior performance, but also, it may be built-out based on demand, and not subject to regulatory restrictions faced by cable television providers.

The availability of a high-speed network 300 that is not geographically restricted, provides an opportunity for existing ISPs (whether or not they operate their own network) to offer their services beyond the geographic limits of their franchise award or agreements with existing network owners. Connectivity between the ISP headend 307 and the common data center 301 provides connectivity between the ISP and the end-users connected to the high-speed network 300 dedicated to broadband data transport services, regardless of the geographic location of those end-users.

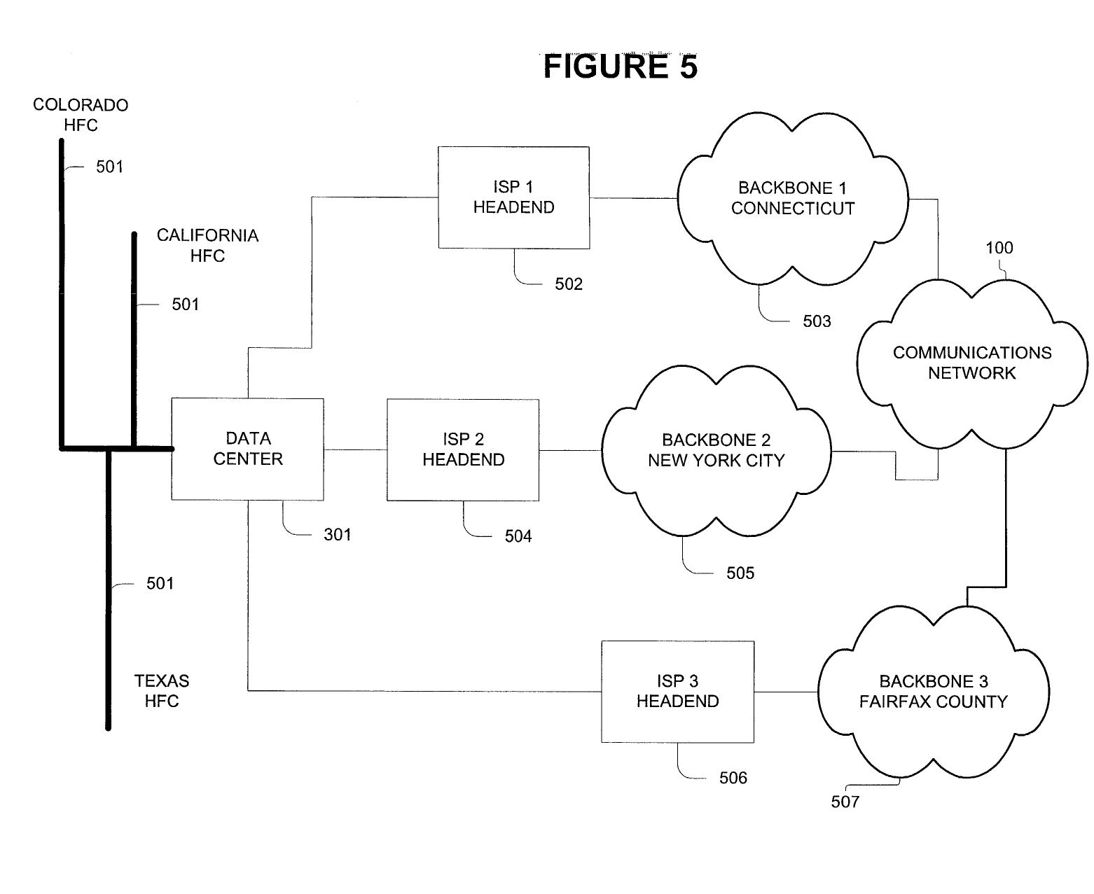

FIG. 5 is a block diagram showing the connectivity of remote customers to geographically based service providers (e.g., ISPs) via the common data center 301 according to one embodiment of the present invention. As shown in FIG. 5, various geographically dispersed HFC networks 501 are connected to a common data center 301. Each of the HFC networks 501 is a high-speed network 300 dedicated to broadband data transport services.

Also shown in FIG. 5 are three exemplary ISP headends 502, 504, 506 representing three ISPs providing connectivity to the Internet 100 via different backbones 503, 505, 507. For example, the ISP 1 headend 502 is connected to the Internet 100 via backbone 1 503 which is based in, for example, Connecticut. In this example, ISP 1 has the cable television franchise for the entire state of Connecticut. Using the system of the present invention, however, ISP 1 would be able to provide ISP services to end-users connected to any one of the HFC networks 501 having connectivity to the common data center 301. Accordingly, ISP 1's Internet access business is no longer restricted to the geographic boundaries of their CATV franchise award.

The common data center 301 of the present invention serves as a clearinghouse for bringing end-users to ISPs. The end-users may be from any geographic area served by the high-speed network 300 dedicated to broadband data transport services. Those customers may or may not be within the geographic boundaries of existing cable television franchise agreements. The ISPs, on the other hand, need not be existing cable television operators. The common data center 301 provides connectivity to end-users for multiple ISPs. The present inventors have recognized that by providing a high-speed network 300 dedicated to broadband data transport services, ISPs gaining access to the high-speed network 300 will be able to (1) offer their customers enhanced Internet access performance since the high-speed network 300 does not have to reserve bandwidth for video (i.e., cable television content), and (2) have the option of extending the geographic reaches of their business.

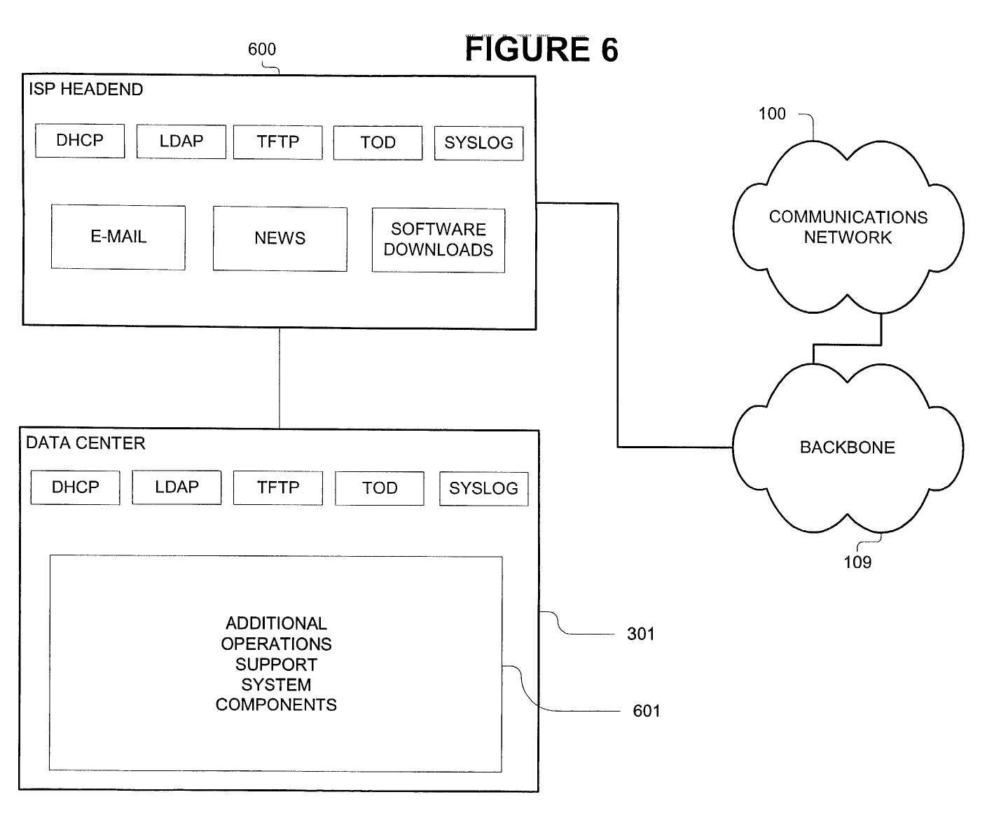

FIG. 6 is a block diagram showing the connectivity between a common data center 301 and an ISP headend 600 according to one embodiment of the present invention. Again, the ISP headend 600 may be for an ISP either having their own network, or an ISP having agreements with network operators (e.g., CATV operators or telephone companies). Both the ISP headend 600 and the common data center 301 provide certain services, such as, for example, Dynamic Host Configuration Protocol (DHCP) services, Lightweight Directory Access Protocol (LDAP) services (typically, but not necessarily integrated with DHCP), Trivial File Transfer Protocol (TFTP) services, Time Of Day (TOD) services, and system logging (SYSLOG) services in order to provide fundamental services to their networks. In one embodiment of the present invention, the ISP headend 600 is further responsible for providing the typical ISP information services provided to the ISP's customers (i.e., the end-users) including, but not limited to e-mail service, news, and software downloads.

The common data center 301 is responsible for managing the high-speed network 300 plant, as well as the interfaces with the various ISPs having customers connected to the high-speed network 300 dedicated to broadband data transport services. While the common data center 301 is responsible for providing services related to the physical aspects of the high-speed network 300 (e.g., network availability, asset management, etc.), the individual ISPs connected to the common data center 301 are each responsible for interfacing with their customers. The common data center 301 provides a single integrated operations support system (OSS) 601 through which the physical aspects of the high-speed network 300 may be managed, and through which the individual ISPs having customers connected to the high-speed network 300 may manage their relationship with the operator of the high-speed network 300 dedicated to broadband data transport services. In one embodiment of the present invention, the operations support system 601 includes a billing capability, a provisioning capability, a general ledger and accounts payable system, a trouble ticketing capability, network monitoring capabilities, service availability capabilities, asset management capabilities, and workforce management capabilities. As would be understood by one of ordinary skill in the software art in light of the present specification, further embodiments of the present invention may include various combinations or sub-combinations of the above-described functional capabilities, or even include additional capabilities including, but not limited to, data warehousing and data mining capabilities.

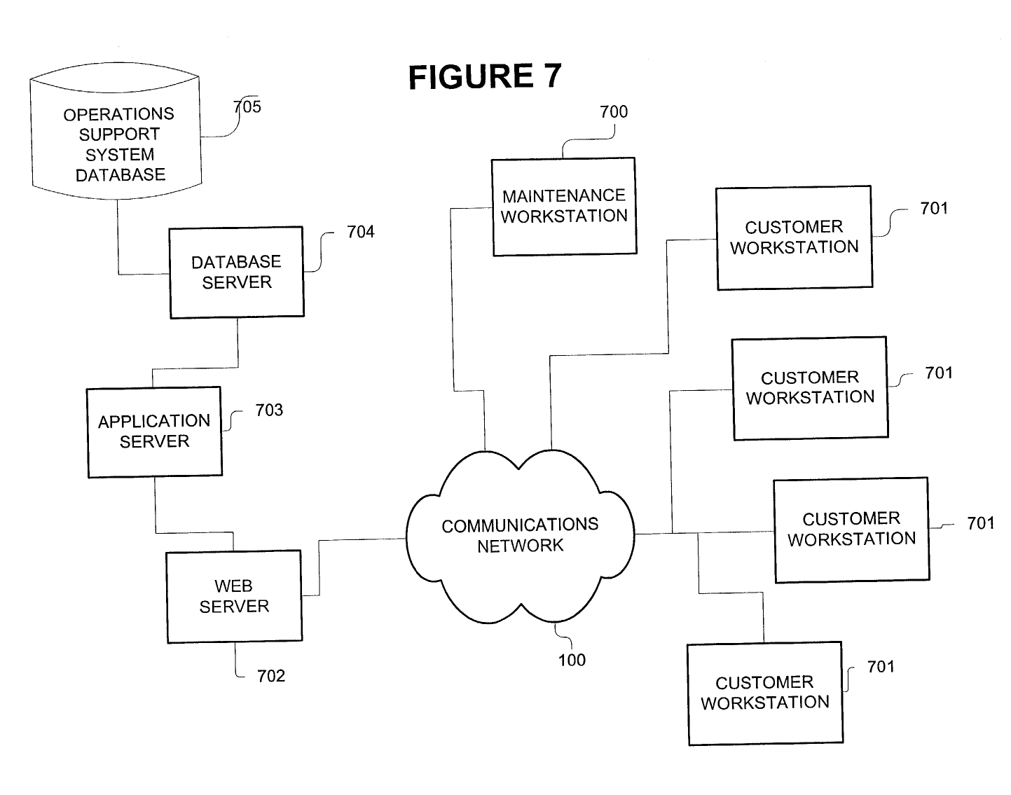

FIG. 7 is a block diagram of a system configuration of an operations support system (OSS) 601 of a common data center 301 as shown in FIG. 6 according to one embodiment of the present invention. As shown in FIG. 7, the system includes a maintenance workstation 700, one or more customer workstations 701 (to provide connectivity for each of the customer ISPS), a communications network 100 (e.g., the Internet), a web server 702, an applications server 703, a database server 704, and an operations support system database 705.

The operations support system database 705 is a digital repository that may be implemented, for example, through a commercially available relational database management system (RDBMS) based on the structured query language (SQL) such as ORACLE, DB2, SYBASE, INFORMIX, or MICROSOFT SQL SERVER, through an object-oriented database management system (ODBMS), or through custom database management software. In one embodiment of the present invention, the operations support system database 705 includes information related to both the physical and usage aspects of the high-speed network 300 dedicated to broadband data transport services.

For example, the operations support system database 705 includes information related to the plant of the high-speed network 300, including, but not limited to, the geographic availability of the network 300 (i.e., where the high-speed network 300 has been built-out), asset management information, workforce management information including work order status information, trouble ticket information, and network event information. The operations support system database 705 also includes information needed by ISPs having customers on the high-speed network 300. In this regard, as an ISP puts one of their customers onto the high-speed network 300, that ISP becomes a customer of the operator of the high-speed network 300. The operations system support database 705, therefore, includes information such as provisioning information, billing information, general ledger information, and accounts payable information that supports the relationship between the operator of the high-speed network 300 and the ISPs having customers connected to the high-speed network 300.

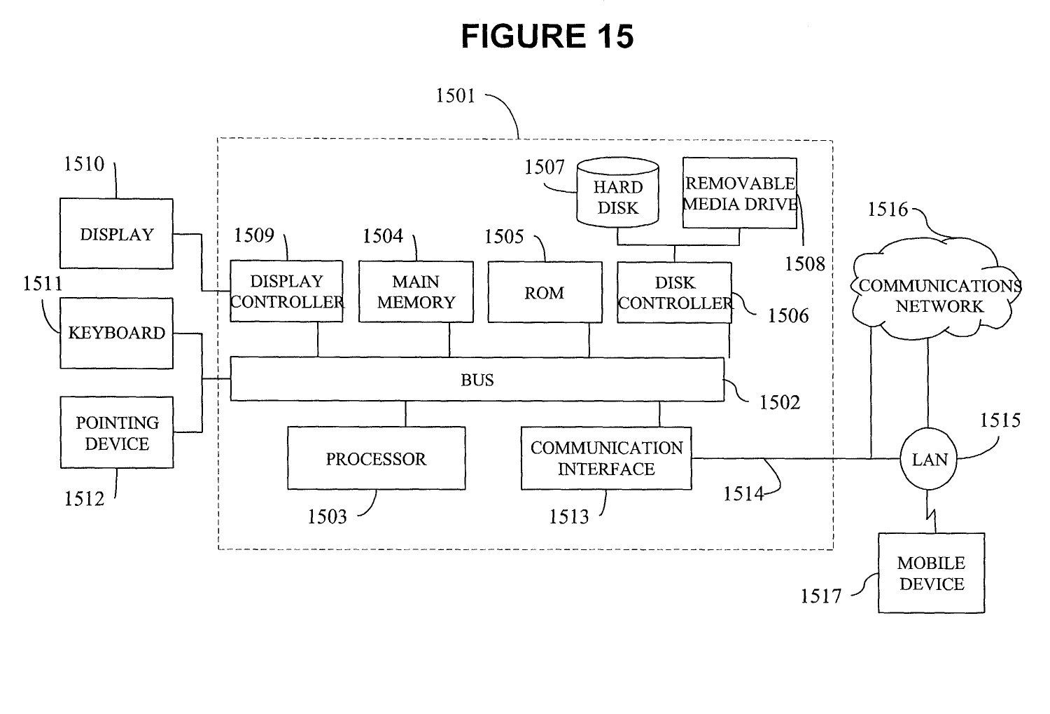

Processes running on the database server 704 maintain the information in the operations support system database 705. The database server 704 is implemented using the computer system 1501 of FIG. 15, for example, but also may be any other suitable personal computer (PC), workstation, server, or device for maintaining the information in the operations support system database 705. The operations support system database 705 may reside on a storage device of the database server 704, or reside on another device connected to the database server 704, for example, by way of a local area network, or other communications link such as a virtual private network, wireless link, or Internet-enabled link.

The applications server 703 may be implemented using the computer system 1501 of FIG. 15, for example, or any other suitable PC, workstation, server, or other device for hosting applications that are used to maintain the various types of information stored in the operations support system database 705. Applications running on the applications server 703 interact with the information held in the operations support system database 705 through the database server 704.

The web server 702 may be implemented using the computer system 1501 of FIG. 15, for example, or any other suitable PC, workstation, server, or other device for hosting an interface through which users may interact with applications running on the applications server 703. In one embodiment of the present invention, the user interface provided by the web server 702 is a world wide web interface accessible through the communications network 100 (e.g., the Internet) via commercially available web browser tools including, but not limited to, INTERNET EXPLORER, available from Microsoft Corporation and NETSCAPE NAVIGATOR, available from Netscape Communications Corporation. The commercially available web browser tool running on the maintenance workstation 700 or the customer workstation 701 provides accessibility to the applications running on the applications server 703 through the web interface provided by the web server 702.

The maintenance workstation 700 may be implemented using the computer system 1501 of FIG. 15, for example, or any other suitable PC, workstation, personal data assistant (PDA), server, or other device for accessing the data in the operations support system database 705 via applications running on the application server 703 through the web based interface provided by the web server 702. In one embodiment, internal personnel may gain access to information in the operations support system database 705 and the applications running on the application server 703 directly (i.e., without going through a common web portal). This direct-access capability is restricted to authorized personnel only. As discussed above, the maintenance workstation 700 may gain access to the web-based interface through a commercially available browser. In one embodiment of the present invention, the maintenance workstation 700 is used to access that information in the operations support system database 705 related to the management of the physical aspects of the high-speed network 300 itself. For example, the maintenance workstation 700 is used to access information relating to network status, trouble ticket status, or work order status. The maintenance workstation 700 is also used for maintaining the operations support system database 705 and the applications running on the application server 703.

The customer workstation 701 may be implemented using the computer system 1501 of FIG. 15, for example, or any other suitable PC, workstation, PDA, server, or other device for accessing information stored in the operations support system database via applications running on the application server 703 through the web based interface provided by the web server 702. As discussed above, the customer workstation 701 may gain access to those applications via a commercially available browser. In one embodiment, the customer workstation 701 is used by ISPs having customers (i.e., end-users) connected to the high-speed network 300. The customer workstation 701 accesses billing information concerning their particular customers, however, ISPs accessing the OSS 601 are restricted from accessing information related to other customers (i.e., other ISPs), nor can they access network management-type information.

In one embodiment of the present invention, strong authentication, authorization and communications integrity are provided for both internal and customer access to the OSS 601. Security may be accomplished through a variety of techniques. For example, security may be imposed at the network level by only accepting traffic from a predetermined set of IP addresses, and by encrypting all data traffic flows using an appropriate technology, such as, for example, Secure Shell (SSH) and Secure HTTP (S-HTTP). User authentication may be performed by using appropriate technologies including, but not limited to, username/password pairs, and one-time password technologies such as SecureID.

The inventors of the present invention have recognized that by providing a single, integrated operations support system (OSS), multiple ISPs can be supported in a secure and authenticated fashion. Internal personnel responsible for the operation of the OSS maintain a single system with which all of their ISP customers interact. By having a single system, only one interface is needed to perform each of the functions supported for the OSS. By not having custom systems or interfaces for each ISP customer, the complexity of the system is decreased, and the reliability of the system is increased, both of which will reduce the cost of maintaining the OSS.

The inventors of the present invention have also recognized that by developing an integrated OSS to have modular architecture and a common database supporting the functions provided by the OSS, components are easily replaced and functionality is easily added or modified. Furthermore, the present inventors have recognized that it is advantageous to have a common web portal for accessing the OSS since the users of the OSS, in particular the ISP customer users, need not develop any software to gain access to the functionality provided. Accordingly, new customers need only have a web browser in order to gain access to the functionality provided by the OSS.

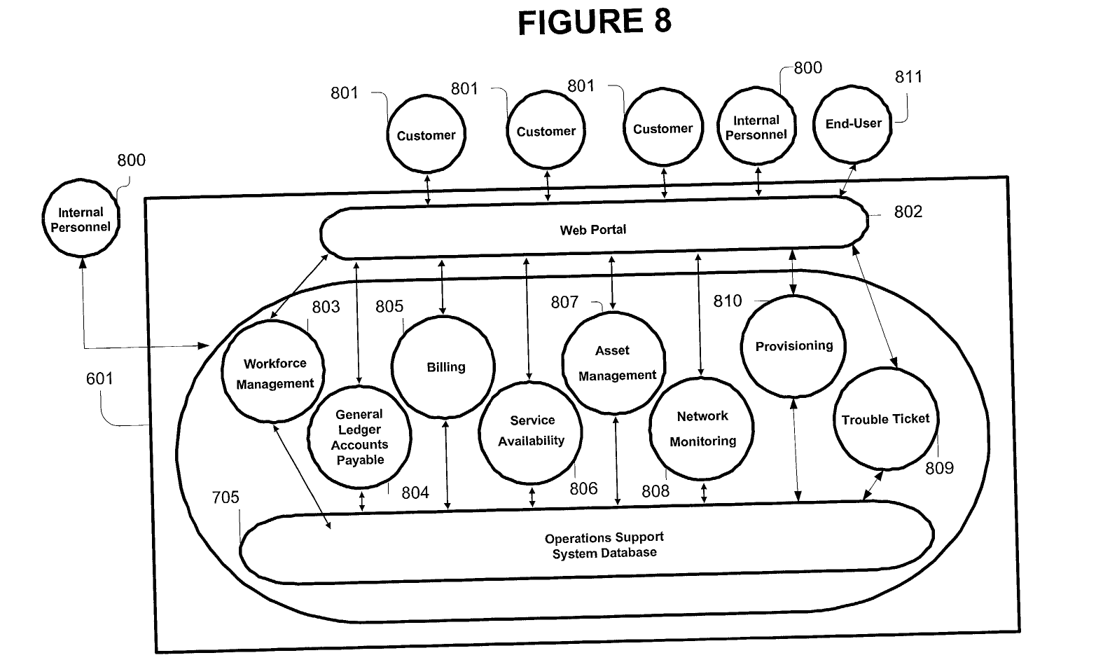

FIG. 8 is a block diagram showing the software architecture of an integrated operations support system (OSS) 601 to support multiple customers (e.g., ISPs) of the high-speed network 300 according to one embodiment of the present invention. As shown in FIG. 8, the architecture provides a single web portal 802 for all users of the OSS 601. In other words, both internal personnel 800 (i.e., those personnel responsible for the operation of the high-speed network 300) and customers 801 (e.g., ISPs having customers connected to the high-speed network 300) access the OSS 601 through a single web-based interface, or web portal 802. The web portal 802 provides a single point of access to a variety of software applications through which information in the operations support system database 705 is manipulated. In one embodiment of the present invention, internal personnel 800 may bypass the web portal 802 to gain access to the applications provided by the OSS 601. In this embodiment, as discussed above, this access is restricted to authorized internal personnel 800 only.

In one embodiment of the present invention, the look and feel of the user interface of the web portal 802 is customizable to facilitate integration with established ISP business processes. In one embodiment, the user interface is branded with the logo of the ISP customer. In a further embodiment, sales scripting language (prompts) defined by the ISP may be used through the user interface. In yet another embodiment, the ISP may be given the ability to control account management functions to control which ISP personnel may have access to the OSS 601 via the web portal 802. Any such desired customizations may be provided on a per-customer basis.

In another embodiment of the present invention the web-based user interface is complemented with automated interfaces for certain functional components, for example, billing and provisioning. Having these automated interfaces results in increased system scalability and ISP process efficiencies. These interfaces may be implemented as, for example, an extensible markup language (XML) interface, a file transfer protocol (FTP) interface, an electronic data interchange (EDI) interface, an interface using the rsync Internet protocol, or an electronic mail (e-mail) interface. In another embodiment of the present invention, OSS 601 functionality is accessible through an application programmer's interface (API).

In one embodiment of the present invention, the operations support system database 705 is implemented as a single master ORACLE relational database providing a single common repository accessed by all applications, whether those applications are supporting internal functions for internal personnel 800, or customer functions supporting customers 801. Further embodiments of the present invention use multiple database instances specific to a particular functionality (e.g., billing, provisioning, network monitoring, etc.), each of which is coordinated through a single master database.

In one embodiment of the present invention, customers 801 interact with the web portal 802 via a customer workstation 701, internal personnel 800 interact with the web portal 802 through a maintenance workstation 700, the web portal 802 is provided by the web server 702, the various applications are hosted by the applications server 703, and the operations support system database 705 is managed by the database server 704.

As shown in FIG. 8, in one embodiment of the present invention, the operations support system 601 includes a workforce management application 803, a general ledger and accounts payable application 804, a billing application 805, a service availability application 806, an asset management application 807, a network monitoring application 808, a trouble ticket application 809, and a provisioning application 810. As discussed above, all of the various software applications are accessible via the common web portal 802 and store and retrieve information from the common operations support system database 705. Of course, the applications included in the OSS 601 may vary with different embodiments of the present invention. The OSS 601 provides an integrated system for managing the high-speed network 300 plant as well as its usage.

As recognized by the present inventors, it is advantageous to provide access to the various applications required to manage the high-speed network 300 itself, as well as its usage, through a common web portal 802 such that customers 801 and internal personnel 800 may access the information stored in the operations support system database 705 by simply having access to a commercially available browser. In other words, no customer software is required by either the operators of the network (i.e., internal personnel 800) or the customers 801 (e.g., ISPs) of the network. Furthermore, the present inventors have recognized that by storing all information in a common operations support system database 705, having a common data model, the sharing of information between the various applications will be facilitated. Moreover, the integrity of the information stored in the operations support system database 705 will be maximized. The present inventors have recognized that it is advantageous, from both a technical and business perspective, to have an integrated OSS 601 based on a common operations support system database 705.

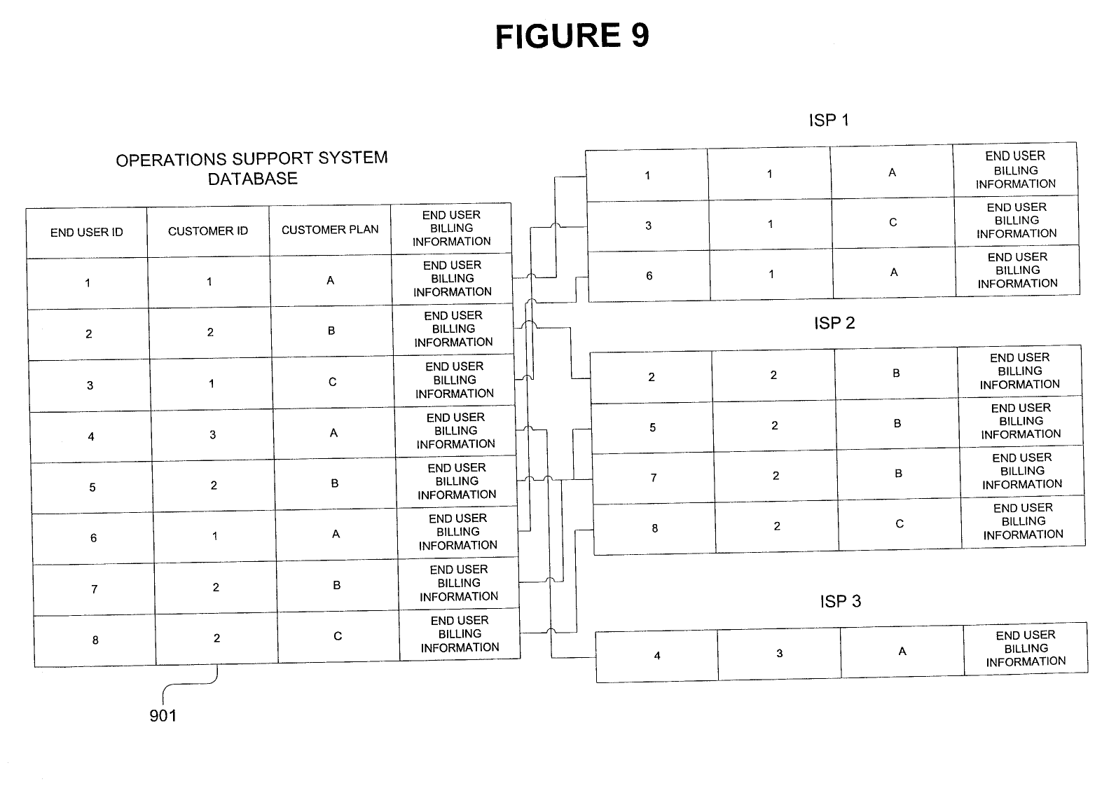

FIG. 9 shows an exemplary database structure for an operations support system database 705 supporting multiple customers 801 (e.g., ISPs) according to one embodiment of the present invention. As shown in FIG. 9, a single query of the operations support system database 705 produces a result 901 that may include several end-users (i.e., individual connections to the high-speed network 300), each end-user being a customer of a particular ISP, each of those ISPs being a customer of the high-speed network 300. Each customer of the high-speed network 300 (e.g., an ISP) may offer a variety of service plans to their customers (i.e., end-users). For example, a particular ISP may offer three different rate plans (e.g., customer plan A, customer plan B, customer plan C). Each of those rate plans would cause different billing information to be generated based on the customer plan subscribed to as defined in the billing application 805 for that particular end-user.

As customers 801 access information stored in the operations support system database 705, they are restricted from viewing any records other than those corresponding to end-users which are their customers. For example, as shown in FIG. 9, when customer ISP 1 accesses the operations support system database 705 via the web portal 802, ISP 1 will only have access to records relating to end-users 1, 3, and 6, as those end-users have a customer-provider relationship with ISP 1. Similarly, when customer ISP 2 accesses the operations support system database 705, ISP 2 will only have access to records pertaining to end-users 2, 5, 7, and 8, and so on. The inventors of the present invention have recognized that from a technical and business perspective, that it is advantageous to store information relating to all of the customers 801 of the high-speed network 300 in a common format in a common operations support system database 705. Accordingly, the operators of the high-speed network 300 need only provide a single user interface to the operations support system 601 that may be accessed by all customers 801. Moreover, the complexity of the operations support system database 705 is minimized, as are the various interfaces between the applications 803-809 and the operations support system database 705. The inventors of the present invention have further recognized that by maintaining information of interest to the operators of the high-speed network 300 and information of interest to the customers 801 in a common operations support system database 705 accessible through a single web portal 802, they have alleviated the need to have separate software applications providing interfaces between a variety of systems.

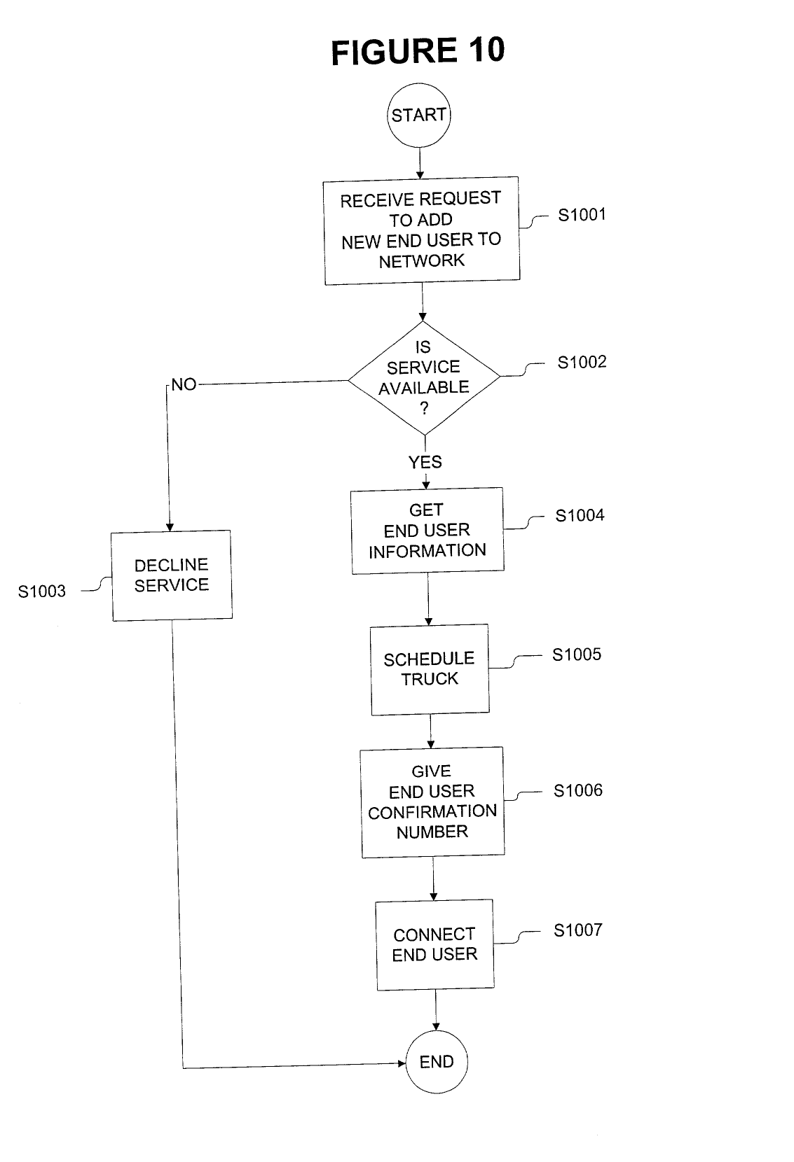

FIG. 10 is a flow diagram showing an exemplary process for provisioning a new end-user for a customer 801 (e.g., an ISP) via an operations support system 601 according to one embodiment of the present invention. As shown in FIG. 10, process begins at step S1001 where a request to add a new end-user to the high-speed network 300 is received by the operations support system 601 through the provisioning application 810. As described above, all customers 801 (e.g., ISPs) of the high-speed network 300 dedicated to broadband data transport services access the OSS 601 through a common web portal 802. Accordingly, the processes described herein related to the OSS 601 may be performed by many customers 801 simultaneously. The OSS 601 maintains the integrity of the single operations support system database as the various customers 801 interact with it.

After the request is received, the process proceeds to step S1002 where it is determined from the operations support system database 705, through the service availability application 806, whether service is available for the end-user requested. If it is determined that the high-speed network 300 is not available in that end-user's geographic area (i.e., “No” at step S1002), the process proceeds to step S1003 where service is declined. If service is declined at step S1003 due to the geographic unavailability of the high-speed network 300 in the requested area, the process ends. As discussed above, the high-speed network 300 dedicated to broadband data transport services is an open access network. Accordingly, the many customers 801 of the high-speed network 300 may compete for and/or serve any end-user desiring connectivity to the high-speed network 300. In this way, the open access paradigm facilitates competition in the ISP marketplace.

If, however, it is determined that the high-speed network 300 is available in the geographic area of the requesting end-user (i.e., “Yes” at step S1002), the process proceeds to step S1004 where the requesting end-user is prompted by the ISP to provide information so that the end-user may be defined to the operations support system database 705, and an installation time may be determined. Once the end-user information has been obtained, the process proceeds to step S1005 where a truck for installing the connectivity to the end-user is scheduled using the workforce management application 803. Once the truck has been scheduled, the process proceeds to step S1006 where the ISP provides the end-user with a confirmation number generated by the workforce management application 803. Once the end-user has been given their confirmation number, the process proceeds to step S1007 where the workorder generated by the workforce management application 803 is executed by the workforce and the end-user has been connected. Once the end-user has been connected, the process of provisioning a new end-user ends.

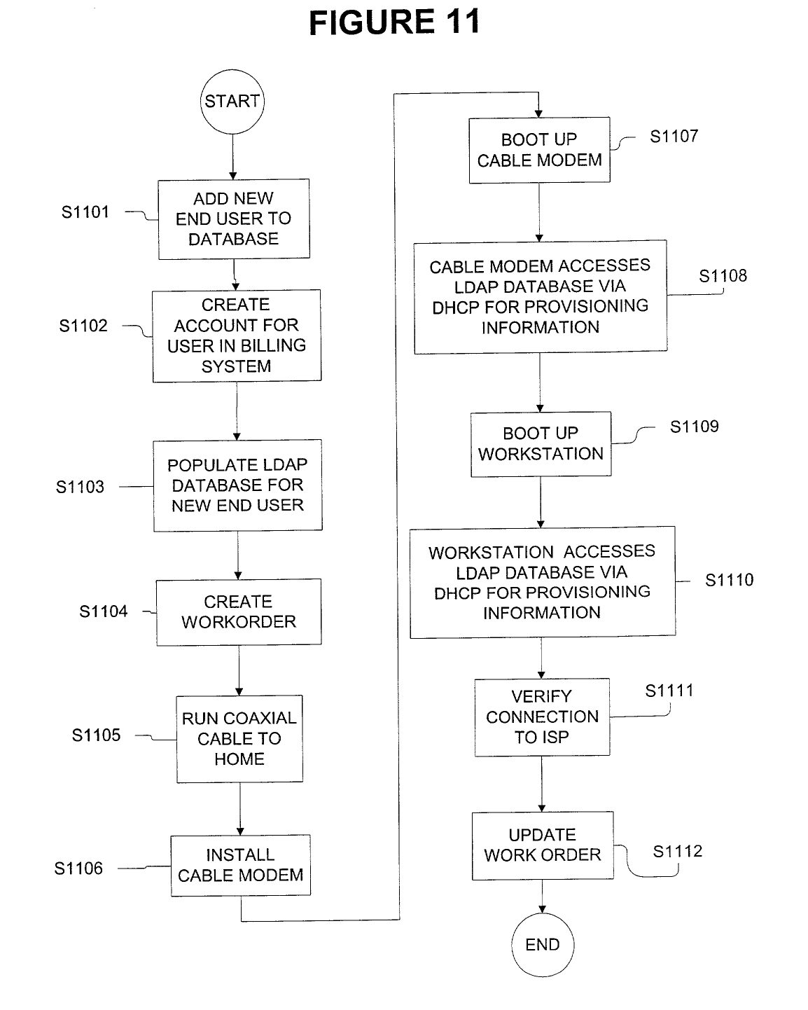

FIG. 11 is a flow diagram showing a process for setting up a new end-user in an operations support system 601 according to one embodiment of the present invention. The process shown in FIG. 11 is used to provide access to the high-speed network 300 for a new end-user identified to the OSS 601 by the process described with respect to FIG. 10 above. FIG. 11 further illustrates the “back end” processes involved in completing the provisioning of a new end-user. As shown in FIG. 11, the process begins at step S1101 where a new end-user is added to the operations support system database 705. The process then proceeds to step S1102 where a new account is created for the end-user through the billing application 805. In one embodiment of the present invention, creating a new account for an end-user will include storing in the operations support system database 705 which ISP the end-user is a customer of. The operations support system database 705 contains all of the network-related information for all served end-users of all ISPs that are customers of the high-speed network 300. Accordingly, storing the ISP for each end-user serves as a convenient field based on which access may be restricted. The process then proceeds to step S1103 where adding a new user (i.e., step S1101) causes a trigger of the operations support system database 705 to populate a LDAP database, which is a directory-specific database that is used in defining the new end-user, with a subset of the service parameters acquired from the new end-user.

The process then proceeds to step S1104 where the information acquired from the new end-user in scheduling an installation appointment is populated in the operations support system database 705. The workforce management application 803 uses this information in generating a workorder for scheduling the truck.

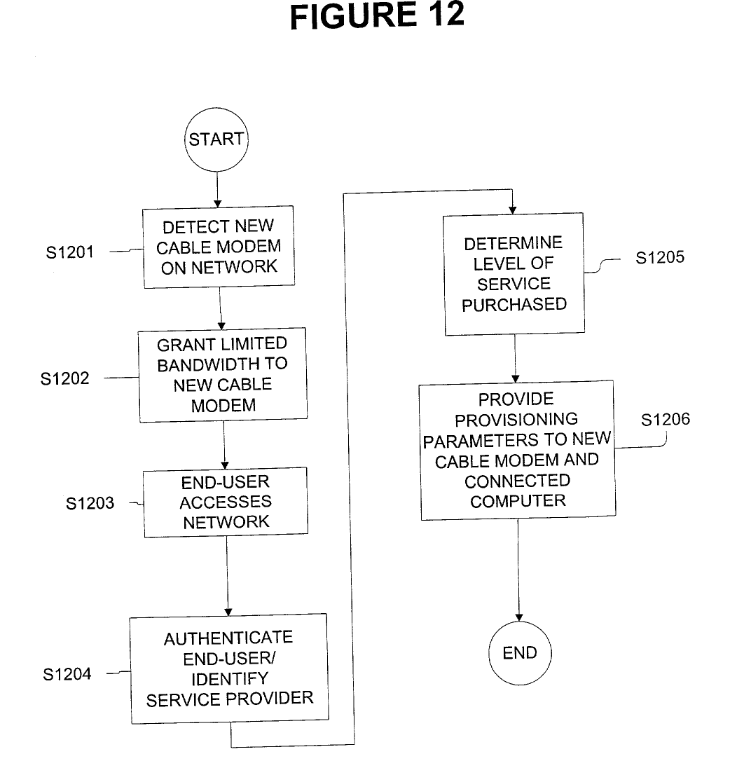

The process then proceeds to step S1105 where coaxial cable is run to the new end-user's home or facility, providing the new end-user with connectivity to the high-speed network 300. Once the connection has been made, the process proceeds to step S1106 where a cable modem is installed at the new end-user's premises. After the cable modem is installed, the process proceeds to step S1107 where the cable modem is booted. After the cable modem is booted, the process proceeds to step S1108 where the cable modem accesses the DHCP server at the common data center 301 to request an IP address for the new end-user and to acquire service information from the LDAP database so that the end-user is provisioned correctly. In another embodiment of the present invention, the service information is stored in the DHCP server alleviating the need to additionally access the LDAP database. The process then proceeds to step S1109 where the workstation connected to the cable modem is booted. Once the workstation is booted, the process proceeds to step S1110 where the workstation will, as with the cable modem, access the DHCP server at the common data center 301 to request the IP address and service information from the LDAP database. In another embodiment of the present invention, the end-user can perform a self-authentication, as described below in the process shown in FIG. 12.

The process then proceeds to step S1111 where the connection to the end-user's ISP (i.e., the customer 801 of the high-speed network 300) is verified. Once the connection to the ISP has been established, the process proceeds to step S1112 where the workorder status is updated in the operations support system database 705 to indicate that the new end-user has been successfully added to the high-speed network 300.

The operators of the high-speed network 300 can interact with their customers 801 (e.g., the ISPs) by accessing records of end-users belonging to a particular customer 801. The different customers 801, on the other hand, can be responsible for maintaining the individual relationships with their particular end-users.

FIG. 12 is a flow diagram showing a process through which an end-user of a high-speed network 300 dedicated to broadband data transport services may self-authenticate and identify their service provider according to one embodiment of the present invention. Using conventional techniques, in order to provision a new cable modem providing access for an end-user, it is necessary to manually enter the media access control (MAC) address of the new cable modem being added to the network. The MAC address is a hardware specific address used to uniquely identify a particular device on a network. By associating a MAC address of a hardware device (i.e., a cable modem) with a level of service purchased from a service provider, it is possible to monitor and control the usage of that hardware device within the parameters of the level of service purchased. Because the MAC address is specific to a particular hardware device, it is typically necessary to track the MAC address of cable modems from inventory through installation. By doing so, the operator of the network can manage the location of the devices, as well as the network services purchased for those devices.

The inventors of the present invention have recognized that this provisioning process may be simplified. In particular, the present inventors recognized that if the operations support system 601 could sense new cable modems as they appeared on the network, and if end-users could identify themselves and their service provider, the OSS 601 could manage the provisioning of that new cable modem without the need to manually track the inventory and installation of that modem.

The process for allowing an end-user to self-authenticate and to identify their service provider begins at step S1201 where the OSS 601 detects a new cable modem on the high-speed network 300 dedicated to broadband data transport services, as a result of the cable modem being connected to the HFC network. At this point the OSS 601 learns the MAC address of the cable modem without human intervention (via an IP address request via the DHCP protocol), and stores this information in the operations support system database 705. The process then proceeds to step S1202 where the OSS 601 will grant limited bandwidth to the new cable modem that was detected in step S1201. The process then proceeds to step S1203 where an end-user accesses the network 300 through the new cable modem (again via an IP address request to the DHCP server). As the end-user accesses the network 300, the OSS 601 directs that end-user to an authentication application. In one embodiment of the present invention, the OSS 601 uses wildcard domain name system (DNS) techniques to direct the end-user by resolving all end-user DNS address resolution requests to the IP address of the authentication application. In another embodiment, policy-based routing techniques are used to force all end-user DNS and web traffic to the authentication application. In yet another embodiment, a tunneling technology such as the Layer Two Tunneling Protocol (L2TP) is used in conjunction with policy-based routing techniques at the routers immediately upstream of the CMTS 302 to force all end-user DNS and web traffic to the authentication application. In yet another embodiment, IP address filters are set in the cable modem 305 to block any destination address other than the IP address of the authentication application. It should be noted that the authentication application will be the only capability accessible by the newly detected end-user until self-authentication and service provider identification has been successfully accomplished.

After the end-user has accessed the network 300, the process proceeds to step S1204 where the end-user authenticates him or herself and specifies the service provider through the authentication application provided by the OSS 601. This authentication consists of the end-user supplying unique token information, which specifies the ISP and validates that the end-user is a provisioned customer of that ISP. Examples of various tokens include, but are not limited to, a username/password pair, an ISP billing account number, or a unique token generated when the ISP first provisioned the end-user per FIG. 10. The end-user does not need to manually enter the MAC address of the cable modem.

The process then proceeds to step S1205 where the authentication application will determine the level of service purchased by that particular end-user from their service provider. This is accomplished by using the OSS database 705 to map the end-user identity to the services provisioned for that end user per FIG. 10. Once the end-user has self-authenticated and identified their service provider, and the level of service purchased has been determined by the OSS 601, the process proceeds to step S1206 where the authentication application of the OSS 601 will provide provisioning parameters to the newly detected cable modem as well as the end-user computer connected to that cable modem.

In the case of the cable modem, the OSS 601 can send a simple network management protocol (SNMP) RESET command to the modem, or the end-user can power cycle the modem (turn it off and then on again). In either case, the modem requests a new dynamic IP address from the DHCP server, at which point the OSS 601 passes to the modem those network and bandwidth parameters that are necessary to support the services the end-user has purchased from their ISP. Similarly, the end-user computer is then rebooted to obtain a new IP address from the DHCP server, at which point the necessary network parameters are downloaded to the computer to achieve connectivity to the ISP via the broadband data transport network 300, (i.e., the end-user is no longer restricted to just the authentication application). At this point, the end-user now has connectivity to all services offered by the ISP, and is thus in-service. The OSS 601 now has in its OSS database 705 the MAC address of the cable modem and the associated dynamic IP address allocated via DHCP, as well as the MAC and dynamic IP address of the associated end-user computer. These data associations can then be used for troubleshooting and usage monitoring purposes.

As recognized by the present inventors, this self-authentication process has several advantages over conventional techniques. For example, using the above process, it is no longer necessary to track the individual cable modems through inventory to installation. Moreover, using the process described herein, it is now possible for an end-user to provide their own cable modem or to replace their cable modem without manual intervention by internal personnel 800.

It was further recognized by the inventors of the present invention that the above-described process will aid in preventing theft of service. By allocating limited bandwidth to newly-detected cable modems, and limiting access to an authentication application until self-authentication has been achieved, the process described above will prevent unauthorized use of an account. Each cable modem will be provisioned for only one end-user account, thereby preventing multiple end-users from using an individual account. Moreover, if a new cable modem is detected for an in-service account (e.g., replacement of a modem due to a defect), the OSS 601 will place the original cable modem back to the limited bandwidth of the authentication state.

As recognized by the present inventors, it is advantageous to provide data logging mechanisms to aid in preventing end-user service abuse. In one embodiment of the present invention, the associations between an end-user computer's MAC address, the DHCP IP address granted to that end-user computer, and the service account information pertaining to that end-user are stored in log files which are made available to ISP customers via access methods which include, but are not limited to FTP, e-mail, web access, and the rsync Internet protocol. Separate log files are created for each ISP customer, and each may access only their particular log files. The ISP customer may use this information in detecting and halting unacceptable end-user use of services as defined by ISP customer acceptable-use policies.

Once the end-user has been successfully connected to their ISP as described above in the context of FIG. 12, the web-portal 802 may be used to change the service parameters of the cable modem at any point in time and for any amount of time. For example, an ISP customer may increase the bandwidth for a particular end-user to accommodate video-on-demand services, or for periods of time when the end-user requires more than their normal level of desired bandwidth. Different levels of service (e.g., guaranteed service level versus best-effort) may also be provisioned at any time and for any amount of time. Once the newly selected service parameters are received via the web portal and stored in the operations support system database 705, the OSS 601 sends an SNMP RESET command to the cable modem, which causes the cable modem to initiate a new DHCP session as described above, which in turn results in the cable modem being loaded with the new service parameters. No end-user authentication is necessary in this case since the end-user is already known to the OSS 601. In a further embodiment, the newly selected service parameters can be received from an automated interface (e.g., an XML interface), rather than from the web portal.

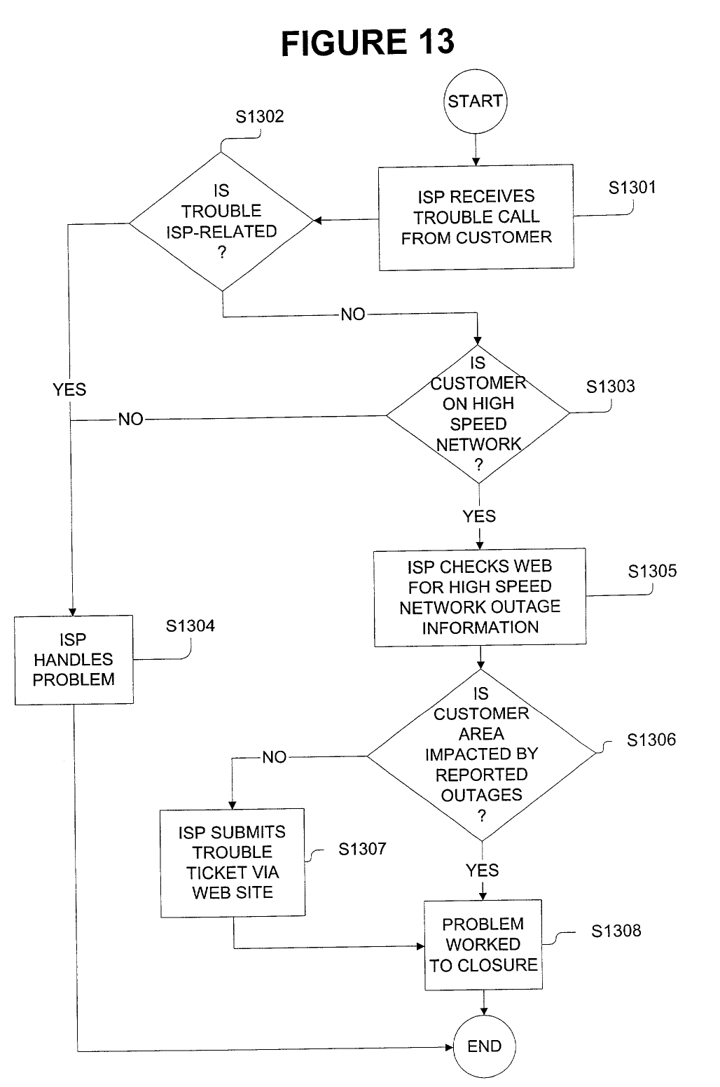

FIG. 13 is a flow diagram showing a process for handling trouble tickets through an operations support system 601 according to one embodiment of the present invention. As shown in FIG. 13, the process begins at step S1301 where an ISP receives a trouble call from an end-user customer of theirs. The process then proceeds to step S1302 where a determination is made as to whether the problem is ISP-related (e.g., problem with e-mail, etc.). If it is determined that the problem is ISP-related (i.e., “Yes” at step S1302), the process proceeds to step S1304 where the ISP will handle the problem. If, on the other hand, it is determined that the problem is not ISP-related (i.e., “No” at step S1302), the process proceeds to step S1303 where the ISP determines whether the end-user is connected to the high-speed network 300 by accessing the appropriate record in the operations support system database 705. As discussed above, each ISP that is a customer of the high-speed network dedicated to broadband data transport services has access to the operations support system database 705. However, as a customer 801 access the operations support system database 705, that customer 801 will be restricted from viewing any information pertaining to end-users not associated with that ISP. If it is determined that the ISP's customer is not connected to the high-speed network 300 (i.e., “No” at step S1303), the process proceeds to step S1304 where the ISP will handle the problem and work the trouble ticket to closure. Once it is determined that the problem is not on the high-speed network 300, and that the ISP is handling the problem, the process ends.

On the other hand, if it is determined that the ISP's customer is connected to the high-speed network 300 (i.e., “Yes” at step S1303), the process proceeds to step S1305 where the ISP will access the operations support system 601 via the web interface to determine the status of the high-speed network 300. All customers 801 of the high-speed network 300 will have access to outage information pertaining to the network 300. The process then proceeds to step S1306 where the ISP will determine, through the network monitoring application 808, whether any reported outages of the high-speed network 300 have been reported in the end-user's geographic area. If it is determined that the ISP's customer is not impacted by any reported outages (i.e., “No” at step S1306), the process proceeds to step S1307 where the ISP will submit a trouble ticket to the operation support system 601 via the web interface. The ISP will access the trouble ticket application 809 via the web interface provided by the web portal 802 to provide the information necessary for the internal personnel 800 (i.e., the operators of the high-speed network 300) to resolve the problem. The process proceeds to step S1308 where the problem will be worked to closure by internal personnel 800 if (1) it is determined that the ISP's customer area is impacted by a reported outage (i.e., “Yes” at step S1305), or (2) the ISP has submitted a trouble ticket through the trouble ticket application 809 at step S1307.

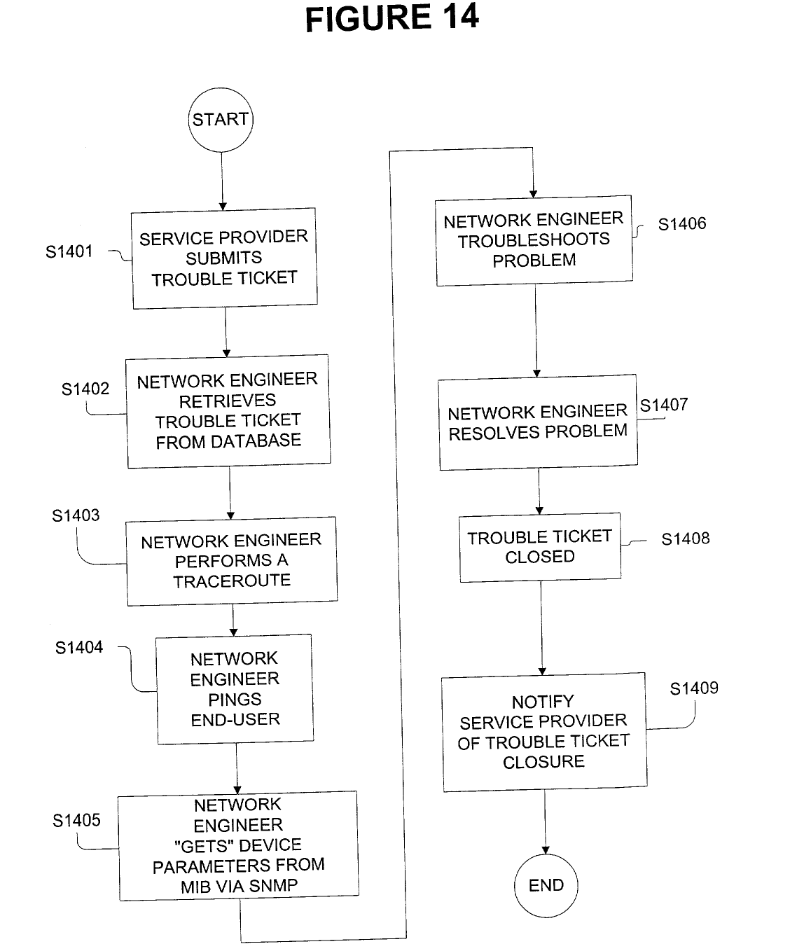

FIG. 14 is a flow diagram showing an exemplary process through which a single trouble ticketing system of an operation support system 601 may concurrently support many service providers (i.e., customers 801) according to one embodiment of the present invention. As shown in FIG. 14, the process begins with step S1401 where a service provider (i.e., a customer 801) submits a trouble ticket to the operation support system 601 through the trouble ticket application 809. The trouble ticket will identify which end-user(s) are experiencing a problem. Once the trouble ticket has been submitted, the information will be stored in the single operations support system database 705. All service providers having end-users connected to the high-speed network 300 dedicated to broadband data transport services will submit trouble tickets through the same mechanism, namely, by accessing the trouble ticket application 809 through the common web portal 802. All trouble tickets entered will be stored in the single operations support system database 705. The service provider customers 801 will be unaware of the fact that their trouble tickets are being stored in the same database as other service providers' trouble tickets. The trouble ticket application 809 will restrict access to all trouble ticket information maintained in the operations support system database 705.

As recognized by the present inventors, by having a single trouble ticket application 809 storing all trouble tickets in a single operations support system database 705, many advantages may be realized. It was the inventors of the present invention that recognized the advantages of having a single trouble ticketing application 809 simultaneously serving all service provider customers 801 of an open access high-speed network 300. Since the internal personnel 800 are responsible for the high-speed network 300, the present inventors recognized the advantages to having an integrated trouble ticket system providing a single repository containing all information of interest to internal personnel 800.

Once the service provider has submitted the trouble ticket, the process proceeds to step S1402 where a network engineer (i.e., internal personnel 800) retrieves the trouble ticket information from the operations support system database 705. The process described in the following text is an exemplary process for troubleshooting a network problem. As would be understood by one of ordinary skill in the network engineering art in light of the present specification, many alternative utilities and techniques may be used in diagnosing and trouble shooting network problems.

Once the trouble ticket information has been retrieved from the operations support system database 705, the process then proceeds to step S1403 where the network engineer performs a traceroute. Traceroute is a network utility that allows the network engineer to determine the specific connectivity path between the common data center 301 and the end-user experiencing a problem. The process then proceeds to step S1404 where the network engineer “pings” the end-user's IP address. If the ping is successful, the process then proceeds to step S1404 where the network engineer obtains device parameters from the cable modem management information base (MIB) using, for example, a simple network management protocol (SNMP) GET command. SNMP and MIBs are Internet protocols, as would be understood by one of ordinary skill in the network art, and are described in detail in Stevens, W., “TCP/IP Illustrated, Volume 1,” Addison-Wesley Publishing Company, Inc., 1994, the entire contents of which is incorporated herein by reference.

The process then proceeds to step S1406 where the network engineer troubleshoots the problem based on the results of the traceroute, ping, and SNMP tools. The process then proceeds to step S1407 where the problem is worked to resolution by the network engineer. The process then proceeds to step S1408 where the trouble ticket information is accessed in the operations support system database 705 and updated to indicate its closure. The process then proceeds to step S1409 where it is determined from the information in the operations support system database 705 which service provider had submitted the trouble ticket, and that service provider is notified as to the closure of that trouble ticket.

As discussed above, the process described in regard to FIG. 14 may be concurrently performed by many different service providers interacting with the single trouble ticket application 809 and the single operations support system database 705. By having all information stored in the single operations support system database 705, internal personnel 800, such as network engineers, can analyze system-wide problems from a single repository. This is a significant improvement over an alternative approach of maintaining individual interfaces with each service provider having end-users connected to the open access high-speed network 300. With the present invention, the network engineers not only have the luxury of dealing with trouble tickets having a common format, but they also benefit from having the ability to ascertain system-wide status by querying a single repository. Moreover, by providing access to the single trouble ticketing application 809 through a single web portal 802, the software maintenance of this capability is greatly simplified.

FIG. 15 illustrates a computer system 1501 upon which an embodiment of the present invention may be implemented. The present invention may be implemented on a single such computer system, or a collection of multiple such computer systems. The computer system 1501 includes a bus 1502 or other communication mechanism for communicating information, and a processor 1503 coupled with the bus 1502 for processing the information. The computer system 1501 also includes a main memory 1504, such as a random access memory (RAM) or other dynamic storage device (e.g., dynamic RAM (DRAM), static RAM (SRAM), and synchronous DRAM (SDRAM)), coupled to the bus 1502 for storing information and instructions to be executed by processor 1503. In addition, the main memory 1504 may be used for storing temporary variables or other intermediate information during the execution of instructions by the processor 1503. The computer system 1501 further includes a read only memory (ROM) 1505 or other static storage device (e.g., programmable ROM (PROM), erasable PROM (EPROM), and electrically erasable PROM (EEPROM)) coupled to the bus 1502 for storing static information and instructions for the processor 1503.

The computer system 1501 also includes a disk controller 1506 coupled to the bus 1502 to control one or more storage devices for storing information and instructions, such as a magnetic hard disk 1507, and a removable media drive 1508 (e.g., floppy disk drive, read-only compact disc drive, read/write compact disc drive, compact disc jukebox, tape drive, and removable magneto-optical drive). The storage devices may be added to the computer system 1501 using an appropriate device interface (e.g., small computer system interface (SCSI), integrated device electronics (IDE), enhanced-IDE (E-IDE), direct memory access (DMA), or ultra-DMA).

The computer system 1501 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1501 may also include a display controller 1509 coupled to the bus 1502 to control a display 1510, such as a cathode ray tube (CRT), for displaying information to a computer user. The computer system includes input devices, such as a keyboard 1511 and a pointing device 1512, for interacting with a computer user and providing information to the processor 1503. The pointing device 1512, for example, may be a mouse, a trackball, or a pointing stick for communicating direction information and command selections to the processor 1503 and for controlling cursor movement on the display 1510. In addition, a printer may provide printed listings of the data structures/information shown in FIGS. 10 and 11, or any other data stored and/or generated by the computer system 1501.

The computer system 1501 performs a portion or all of the processing steps of the invention in response to the processor 1503 executing one or more sequences of one or more instructions contained in a memory, such as the main memory 1504. Such instructions may be read into the main memory 1504 from another computer readable medium, such as a hard disk 1507 or a removable media drive 1508. One or more processors in a multi-processing arrangement may also be employed to execute the sequences of instructions contained in main memory 1504. In alternative embodiments, hard-wired circuitry may be used in place of or in combination with software instructions. Thus, embodiments are not limited to any specific combination of hardware circuitry and software.

As stated above, the computer system 1501 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1501, for driving a device or devices for implementing the invention, and for enabling the computer system 1501 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1503 for execution. A computer readable medium may take many forms, including but not limited to, non-volatile media, volatile media, and transmission media. Non-volatile media includes, for example, optical, magnetic disks, and magneto-optical disks, such as the hard disk 1507 or the removable media drive 1508. Volatile media includes dynamic memory, such as the main memory 1504. Transmission media includes coaxial cables, copper wire and fiber optics, including the wires that make up the bus 1502. Transmission media also may also take the form of acoustic or light waves, such as those generated during radio wave and infrared data communications.

Various forms of computer readable media may be involved in carrying out one or more sequences of one or more instructions to processor 1503 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1501 may receive the data on the telephone line and use an infrared transmitter to convert the data to an infrared signal. An infrared detector coupled to the bus 1502 can receive the data carried in the infrared signal and place the data on the bus 1502. The bus 1502 carries the data to the main memory 1504, from which the processor 1503 retrieves and executes the instructions. The instructions received by the main memory 1504 may optionally be stored on storage device 1507 or 1508 either before or after execution by processor 1503.

The computer system 1501 also includes a communication interface 1513 coupled to the bus 1502. The communication interface 1513 provides a two-way data communication coupling to a network link 1514 that is connected to, for example, a local area network (LAN) 1515, or to another communications network 1516 such as the Internet. For example, the communication interface 1513 may be a network interface card to attach to any packet switched LAN. As another example, the communication interface 1513 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1513 sends and receives electrical, electromagnetic or optical signals that carry digital data streams representing various types of information.

The network link 1514 typically provides data communication through one or more networks to other data devices. For example, the network link 1514 may provide a connection to another computer through a local network 1515 (e.g., a LAN) or through equipment operated by a service provider, which provides communication services through a communications network 1516. In preferred embodiments, the local network 1514 and the communications network 1516 preferably use electrical, electromagnetic, or optical signals that carry digital data streams. The signals through the various networks and the signals on the network link 1514 and through the communication interface 1513, which carry the digital data to and from the computer system 1501, are exemplary forms of carrier waves transporting the information. The computer system 1501 can transmit and receive data, including program code, through the network(s) 1515 and 1516, the network link 1514 and the communication interface 1513. Moreover, the network link 1514 may provide a connection through a LAN 1515 to a mobile device 1517 such as a personal digital assistant (PDA), laptop computer, or cellular telephone. The LAN communications network 1515 and the communications network 1516 both use electrical, electromagnetic or optical signals that carry digital data streams. The signals through the various networks and the signals on the network link 1514 and through the communication interface 1513, which carry the digital data to and from the system 1501, are exemplary forms of carrier waves transporting the information. The computer system 1501 can transmit notifications and receive data, including program code, through the network(s), the network link 1514 and the communication interface 1513.

Obviously, numerous modifications and variations of the present invention are possible in light of the above teachings. It is therefore to be understood that within the scope of the appended claims, the invention may be practiced otherwise than as specifically described herein.

1. A method for expanding customer bases for data services providers, comprising the steps of:
connecting a first end-user of a first data services provider to a high-speed network dedicated to broadband data transport services, the high-speed network being at least one of a hybrid fiber optic coaxial network and an all-fiber optic network;
connecting a second end-user of a second data services provider to the high-speed network;
connecting the first end-user to a headend of the first data services provider through a common data center of the high-speed network; and
connecting the second end-user to a headend of the second data services provider through the common data center of the high-speed network, wherein
the high-speed network is owned by a third party, not the first data services provider and not the second data services provider.

2. The method of claim 1, wherein the first end-user is geographically located outside of a peripheral reach of a communications plant operated by the first data services provider, the communications plant being at least one of a hybrid fiber optic coaxial network and an all-fiber optic network.

3. The method of claim 1, wherein the headend of the first data services provider is a headend for at least one of CATV signals and data.

4. The method of claim 2, wherein:
the communications plant operated by the first data services provider carry CATV signals; and
the peripheral reach of the communications plant is restricted by a governmental regulatory authority.

5. The method of claim 4, wherein the communications plant carries CATV signals to other end-users, but not the first end-user.

6. The method of claim 1, further comprising the steps of:
storing a first end-user entry in a database of the common data center corresponding to the first end-user;
associating the first end-user entry with the first data services provider in the database;
storing a second end-user entry in the database of the common data center corresponding to the second end-user; and
associating the second end-user entry with the second data services provider in the database.

7. A method for supplementing subscribership for data services of a service provider that provides at least one of CATV services and data services in first geographic area, comprising the steps of:
obtaining a contract from the service provider to provide data services for an end-user, the end-user located outside of the first geographic area;
provisioning the end-user for data services;
storing an end-user entry in a database corresponding to the end-user;
associating the end-user entry with the service provider in the database; and
connecting the end-user to a communication line operated by the service provider via a high speed data network.

8. The method of claim 7, wherein the communications line operated by the service provider is connected to a headend through which at least one of CATV signals and data signals are transmitted.

9. The method of claim 8, wherein a peripheral reach of the communications line which carries the CATV signals is restricted by a governmental regulatory authority.

10. A method for expanding customer bases for data services providers, comprising the steps of:
executing a subscription contract between a third party and a first data service provider to connect a first end-user to a high-speed network dedicated to broadband data transport services operated by the third party;
executing another subscription contract between the third party and a second data service provider to connect a second end-user to the high-speed network;
connecting the first end-user to a headend of the first data service provider through a common data center of the high-speed network; and
connecting the second end-user to a headend of the second data service provider through the common data center of the high-speed network.

11. The method of claim 10, wherein at least one of the first data service provider and the second data service provider also provide cable television signals to communication lines connected to their respective headends.

12. A method for reusing computer resources to provide operations support services to a plurality of Internet service providers with different customer bases, comprising the steps of:
populating a digital repository with entries including information about end-users of a first Internet service provider;
populating the digital repository with entries including information about end-users of a second Internet service provider, the second Internet service provider being different from the first Internet service provider;
presenting a graphical user interface to the first Internet service provider when seeking to at least one of access, create, and update the information about end-users of the first Internet service provider; and
presenting the graphical user interface to the second Internet service provider when seeking to at least one of access, create, and update the information about end-users of the second Internet service provider.

13. The method of claim 12, further comprising the step of:
providing from the first Internet service provider cable television service to other end-users, but not to the end-users of the first Internet service provider.

14. A method for promoting competition between cable providers offering broadband data services, comprising steps of:
connecting an end-user to a high-speed data network dedicated to broadband data transport services;
connecting a headend of a first broadband data services provider to the high-speed data network so as to create a physical communication link between the end user and the headend of the first broadband data services provider;
connecting a headend of a second broadband data service provider to the high speed data network so as to create another physical communication link between the end user and the headend of the second broadband data services provider; and
determining if the end-user selects to subscribe to data services offered by one of the first broadband data services provider and the data services offered by the second broadband data services provider;
enabling the physical communication link between the end-user and the first broadband data services provider if in the determining step it is determined that the end-user selects the data services of the first broadband data services provider; and
enabling the physical communication link between the end-user and the second broadband data services provider if in the determining step it is determined that the end-user selects the data services of the second broadband data services provider.

15. The method of claim 14, wherein the high-speed data network does not carry cable television signals.

16. A system for expanding customer bases for broadband data services providers, comprising:
means for connecting a first end-user of a first data services provider to a high-speed network dedicated to broadband data transport services, the high-speed network being at least one of a hybrid fiber optic coaxial network and an all-fiber optic network;
means for connecting a second end-user of a second data services provider to the high-speed network;
means for connecting the first end-user to a headend of the first data services provider through a common data center of the high-speed network; and
means for connecting the second end-user to a headend of the second data services provider through the common data center of the high-speed network, wherein
the high-speed network is owned by a third party, not the first data services provider and not the second data services provider.

17. The system of claim 16, wherein the first end-user is geographically located outside of a peripheral reach of a communications plant operated by the first data services provider, the communications plant being at least one of a hybrid fiber optic coaxial network and an all-fiber optic network.

18. The system of claim 17, wherein the headend of the first data services provider is a head end for at least one of CATV signals and data signals.

19. The system of claim 16, further comprising:
means for storing a first end-user entry in a database of the common data center corresponding to the first end-user;
means for associating the first end-user entry with the first data services provider in the database;
means for storing a second end-user entry in the database of the common data center corresponding to the second end-user; and
means for associating the second end-user entry with the second data services provider in the database.

20. A system for supplementing subscribership for data services of a service provider that provides CATV and data services in first geographic area, comprising:
means for providing data services for an end-user from the service provider, the end-user located outside of the first geographic area;
means for provisioning the end-user for data services;
means for storing an end-user entry in a database corresponding to the end-user;
means for associating the end-user entry with the service provider in the database; and
means for connecting the end-user to a communication line operated by the service provider by a high speed data network.

21. The system of claim 20, wherein the communications line operated by the service provider is connected to a headend through which at least one of data signals and CATV signals are transmitted.

22. The system of claim 21, wherein
a peripheral reach of the communications line which carries the CATV signals is restricted by a governmental regulatory authority.

23. A system for reusing computer resources to provide operations support services to a plurality of Internet service providers with different customer bases, comprising:
means for populating a digital repository with entries regarding information about end users of a first Internet service provider;
means for populating the digital repository with entries including information about end-users of a second Internet service provider, the second Internet service provider being different from the first Internet service provider;
means for presenting a graphical user interface to the first Internet service provider when seeking to at least one of access, create, and update the information about end-users of the first Internet service provider; and
means for presenting the graphical user interface to the second Internet service provider when seeking to at least one of access, create, and update the information about end-users of the second Internet service provider.

24. The system of claim 23, further comprising:
means for providing from the first Internet service provider cable television service to other end-users, but not to the end-users of the first Internet service provider.

25. A system for promoting competition between cable providers offering broadband data services, comprising:
means for connecting an end-user to a high-speed data network dedicated to broadband data transport services;
means for connecting a headend of a first broadband data services provider to the high-speed data network so as to create a physical communication link between the end-user and the headend of the first broadband data services provider;
means for connecting a headend of a second broadband data service provider to the high-speed data network so as to create another physical communication link between the end-user and the headend of the second broadband data services provider; and
means for determining if the end-user selects to subscribe to data services offered by one of the first broadband data services provider and the data services offered by the second broadband data services provider; and
means for enabling the physical communication link between the end-user and the first broadband data services provider if the means for determining determines that the end-user selects the data services of the first broadband data services provider; and
means for enabling the physical communication link between the end-user and the second broadband data services provider if the means for determining determines that the end-user selects the data services of the second broadband data services provider.

26. The system of claim 25, wherein the high-speed data network does not carry cable television signals.
